(19) United States
(12) Patent Application Publication
(10) Pub. No.: US 2015/0084372 A1
(43) Pub. Date: Mar. 26, 2015

(54) MOVEABLE AERODYNAMIC DEVICE FOR A VEHICLE

(71) Applicant: McLaren Automotive Limited, Woking (GB)

(72) Inventors: Duncan Green, Woking (GB); Robert Allen, Woking (GB); Jae Lee, Woking (GB)

(21) Appl. No.: 14/497,139

(22) Filed: Sep. 25, 2014

(30) Foreign Application Priority Data
Sep. 25, 2013 (GB) 1316997.4

(51) Int. Cl. B62D 35/00

(52) U.S. Cl. CPC B62D 35/007
USPC 296/180.5

(57) ABSTRACT

A vehicle comprising: a vehicle body; an openable door having an outer skin and an inner skin defining a cavity there between and a relay mechanism mounted in the cavity; a moveable aerodynamic device attached to the door for generating down force when in a deployed position relative to the vehicle; and an actuator mounted to the vehicle body; the vehicle being configured so that (i) the door can be opened, leaving the actuator mounted to the body, and (ii) when the door is closed, the actuator can engage the relay mechanism and drive the aerodynamic device via the relay mechanism to cause the aerodynamic device to extend to the deployed position.

### CROSS-REFERENCE TO RELATED APPLICATIONS

This patent application claims priority to Great Britain Patent Application GB 1316997.4, filed Sep. 25, 2013, entitled “Moveable Aerodynamic Device for a Vehicle,” which is incorporated by reference.

### BACKGROUND

This invention relates to a moveable aerodynamic device for a vehicle, for example an air-brake or wing.

Moveable aerodynamic devices can be fitted to a vehicle to improve the vehicle's performance, for example by increasing the down force generated by the vehicle or increasing the vehicle's stopping power. Aerodynamic devices that operate to increase the down force generated by the vehicle, e.g. a wing, often increase the drag as a by-product of the increased down force. Other aerodynamic devices, e.g. airbrakes, increase the stopping power of a vehicle directly through an increase in drag. It is often undesirable for a vehicle to generate high levels of drag except for under braking as it decreases the vehicle's straight-line performance.

Aerodynamic devices may be moveable with respect to the vehicle so that they only have a material effect on the airflow over the vehicle under a suitable set of circumstances. For example, a device may be configured so that it lies substantially flush with the bodywork of the vehicle when in an ‘inactive’ state so that it has a minimal effect on the airflow over the vehicle. If it is desirable for the aerodynamic device to alter the airflow over the vehicle, for example to increase the down force or to increase the drag to aid braking, the device can be moved relative to the bodywork. Controlling the movement of the aerodynamic devices allows the vehicle to benefit from the improved performance afforded by the aerodynamic device without being unnecessarily compromised in its straight-line performance.

An example of an aerodynamic device used to improve the braking performance of a vehicle is the air-brake. Typically, an air-brake will be in the form of a panel which lies substantially flush with, or substantially close to, the upper bodywork of the vehicle when it is not needed. When the vehicle is undergoing braking, the air-brake can be deployed so that at least part of the panel is raised relative to the upper bodywork of the vehicle. In certain vehicles, for example the Bugatti Veyron, both the front and rear edges of the panel are raised relative to the upper bodywork when the air-brake is deployed, with the rear edge being raised higher above the bodywork than the front edge. In other vehicles, for example the McLaren Mercedes SLR, the panel is tilted about its front edge when the air-brake is deployed so that the rear edge of the panel is raised relative to the upper bodywork and there is no substantial vertical gap between the front edge and the adjacent upper bodywork.

An example of an aerodynamic device used to increase the down force is a rear wing. Similarly to the airbrake, a rear wing will typically consist of a panel which may be raised relative to the bodywork of the vehicle in order to increase the down force generated by the vehicle. In certain vehicles, for example the Porsche Panamera, the panel is flush with the bodywork when in a retracted position. The panel is moveable so that it becomes raised relative to the bodywork. In the Panamera, the panel may be positioned such that the front and rear edges of the panel are at substantially same height relative to the ground. If the vehicle determines that more down force is required the rear edge of the panel may be raised higher relative to the ground than the front edge.

For moveable airbrakes and/or rear wings, the movement of the panel is often controlled by one or more actuators. The McLaren MP4-12C for example, has an active rear aerodynamic device comprising a panel that is controlled by a linear actuator that is mounted between the body of the vehicle and a portion of the panel. With this design the actuator has the dual role of controlling the movement of the panel during deployment of the air-brake and providing structural support to the panel and air-brake mechanism when deployed. With this design it is desirable for the actuator to be able to withstand a substantial portion of the force generated by the air-brake in order to constrain unwanted motion of the panel. Naturally, mounting an actuator between the body of the vehicle and the panel results in certain packaging restrictions within the vehicle where the air-brake system is housed.

It is often the case that a deployable rear-wing or air-brake is positioned on an openable door of the vehicle, for example the rear boot or tailgate of the vehicle. In the Porsche Panamera for example, the deployable rear-wing forms part of the body work of the rear boot (trunk) when in a retracted position. In such designs the mechanism for controlling the movement of the panel, e.g. the actuators, is housed within the door. This can lead to a substantial increase to the weight of the door, which often has to be opened manually by a user.

It would therefore be desirable for a variable aerodynamic device, e.g. a rear wing or air-brake, to be fitted to an openable door of a vehicle without adding excessive weight to the door or compromising the packaging of the aerodynamic device within the vehicle.

### BRIEF SUMMARY OF THE INVENTION

According to a first aspect of the present invention there is provided a vehicle comprising: a vehicle body; an openable door having an outer skin and an inner skin defining a cavity there between and a relay mechanism mounted in the cavity; a moveable aerodynamic device attached to the door for generating down force when in a deployed position relative to the vehicle; and an actuator mounted to the vehicle body; the vehicle being configured so that (i) the door can be opened leaving the actuator mounted to the body, and (ii) when the door is closed the actuator can engage the relay mechanism and drive the aerodynamic device via the relay mechanism to cause the aerodynamic device to extend to the deployed position.

Suitably the vehicle is configured so that when the door is opened the relay mechanism and the door move together. The openable could be a boot lid. The actuator could suitably be a linear actuator.

Suitably the relay mechanism comprises a plunger constrained to move in a linear motion. The plunger could be attached to the aerodynamic device at a first location on the device. The plunger could be pivotally attached to the aerodynamic device.

Suitably the vehicle is configured so that when the door is closed the actuator can engage the plunger and drive the aerodynamic device via the plunger to cause the aerodynamic device to extend to the deployed position.

The actuator could be linearly extendable from a retracted position to a deployed position and the extension of the actuator could engage the plunger and drives the plunger to move in a linear motion to cause the aerodynamic device to extend to the deployed position.

The vehicle could be configured so that when the actuator has engaged the plunger, the actuator and the plunger move together.

Suitably the aerodynamic device is extendable to the deployed position from a retracted position.

The aerodynamic device could lie substantially flush with the outer skin of the openable door when in the retracted position. The aerodynamic device could comprise a wing element.

According to a second aspect of the present invention there is provided a vehicle comprising: a vehicle body; an aerodynamic device moveable between a retracted position and an extended position relative to an outer surface of the vehicle; an actuator for moving the aerodynamic device relative to the outer surface of the vehicle; and a support connected to the actuator via a laterally mobile connection, the support being constrained by means independent of the actuator for resisting a force generated by the aerodynamic device in the direction of the primary airflow over the aerodynamic device when the vehicle is in motion, and for engaging with the actuator to cause the aerodynamic device to move between the retracted position and the extended position.

The support could comprise a mounting structure attached to the vehicle for resisting the force generated by the aerodynamic device. The support could comprise a plunger constrained to move in a linear motion and configured to engage with the actuator so as to move the aerodynamic device between the retracted position and the extended position.

Suitably the plunger is connected to the actuator via the laterally mobile connection.

The plunger could be constrained to move in a linear motion by the mounting structure. The plunger could move in a linear motion through a channel extending through the mounting structure.

The actuator could extend into the channel when engaged with the plunger to move the aerodynamic device between the retracted position and the extended position.

The support could be attached to the aerodynamic device at a first location on the device. Suitably the plunger could be pivotally attached to the aerodynamic device at a first location on the device.

Suitably the actuator is mounted to the vehicle body independently of the mounting structure. The aerodynamic device could lie substantially flush with the outer surface of the vehicle when in the retracted position.

Suitably the laterally mobile connection could be a spherical joint. Alternatively the laterally mobile connection could comprise a bushing.

### BRIEF DESCRIPTION OF THE FIGURES

FIG. 1 is a side view of a moveable aerodynamic device attached to an openable door of a vehicle where the aerodynamic device is in a retracted position.

FIG. 2 is a side view of a moveable aerodynamic device attached to an openable door of a vehicle where the door is in an opened position.

FIG. 3 is a side view of a moveable aerodynamic device attached to an openable door of a vehicle where the aerodynamic device is in a deployed position.

FIG. 4a is a side view of a moveable aerodynamic device attached to an openable door of a vehicle and a system for moving the aerodynamic device, where the aerodynamic device is in a retracted position.

FIG. 4b is a side view of a moveable aerodynamic device attached to an openable door of a vehicle and a system for moving the aerodynamic device, where the aerodynamic device is functioning as a rear-wing.

FIG. 4c is a side view of a moveable aerodynamic device attached to an openable door of a vehicle and a system for moving the aerodynamic device, where the aerodynamic device is functioning as an airbrake.

FIG. 5 is a side view of a moveable aerodynamic device attached to a vehicle body via a laterally mobile connection.

### DETAILED DESCRIPTION

The apparatus described below provides a means for fitting a moveable aerodynamic device to an openable door of a vehicle without excessively increasing the weight of the door. Furthermore an apparatus is described that provides a means to attach a moveable aerodynamic device to a vehicle in a manner that reduces the design restrictions placed on the actuator used for moving the device. Reducing the design restrictions on the actuator has the associated advantage of greater freedom for packaging the aerodynamic device and its control mechanisms within the vehicle, as will be described in more detail below.

The following description will be made with reference to an aerodynamic device functioning as an airbrake. This is for the purposes of illustration only, and the apparatus described herein is equally applicable to other suitable moveable aerodynamic devices, for example a wing, a spoiler or another flow-guiding element.

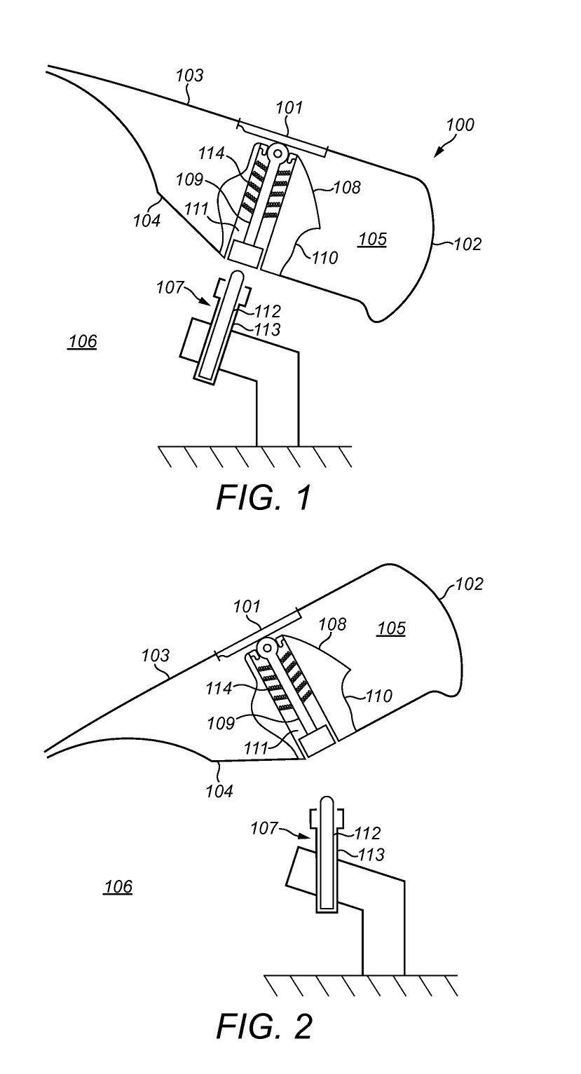

FIG. 1 shows a side view of a section of a vehicle body comprising a system 100 used to actively control the movement of an aerodynamic device 101 attached to a door 102, where the door is moveable relative to the vehicle body. The aerodynamic device is in the form of a wing element which extends laterally across at least a portion of the vehicle's width and is aerodynamically profiled so that it is capable of providing the down force and braking effects described below. The wing element is continuously moveable between a retracted position and a deployed position so as to provide a particular down force or braking effect.

In more detail, the door 102 comprises an outer skin 103 and a lower skin 104 which define a cavity 105 there between. Preferably the door is openable by a user. Suitably, the outer skin could be a sheet that forms part of the upper bodywork of the vehicle. The lower skin could suitably be a sheet that defines a boundary between the door 102 and a section within the vehicle 106 which is accessible by a user when the door is opened. For example, the door could be a tailgate or a boot lid, in which case opening the door provides a user access to storage space or the boot of the vehicle. The vehicle further comprises an actuator 107 for moving the aerodynamic device relative to the upper bodywork of the vehicle. Preferably the actuator is mounted to the body of the vehicle, for example to the vehicle chassis. Attached to the aerodynamic device is a relay mechanism 108 housed within the cavity of the door. Suitably, the relay mechanism is configured to engage the actuator so as to move the aerodynamic device.

The vehicle comprises two actuators and relay mechanisms positioned symmetrically about the centreline of the vehicle. Only the left hand side actuator and relay mechanism is shown in FIGS. 1 to 5, but the right hand side systems are congruent.

The relay mechanism is arranged so that, when engaged with the actuator 107, motion of the actuator is coupled via the relay mechanism to the aerodynamic device so as to move the aerodynamic device. That is, the actuator engages the relay mechanism and drives the aerodynamic device via the relay mechanism so as to move the aerodynamic device. The relay mechanism comprises a plunger 109. Suitably, the plunger comprises a shaft extending from a base portion, with the upper end of the shaft being pivotally attached to the wing element. The plunger is constrained to move in a linear motion in response to motion of the actuator so as to move the aerodynamic device with respect to the vehicle.

The relay mechanism further provides a means for mounting the aerodynamic device to the vehicle. This is achieved by means of a mounting structure 110 that is rigidly mounted to the lower skin of the door. The mounting structure contains a hollow channel 111 through which the plunger can move and which extends the length of the structure. Suitably, the base portion of the plunger is shaped such that it is contiguous with the inner surface of the structure defined by the channel and so that the channel can constrain the plunger to move in a linear motion. The hollow channel is congruent with an opening in the lower skin.

The actuator is mounted to the body of the vehicle, for example the vehicle chassis, by way of a support structure. The actuator comprises a piston 112 linearly moveable within a hollow cylinder jacket 113 that is connected to the support structure. The actuator engages the plunger so as to move the aerodynamic device by moving the piston within the jacket 113 so that the upper end of the piston connects with the base portion of the plunger, thereby coupling the motion of the piston to the plunger. This process will now be described in more detail with reference to FIGS. 1 to 3.

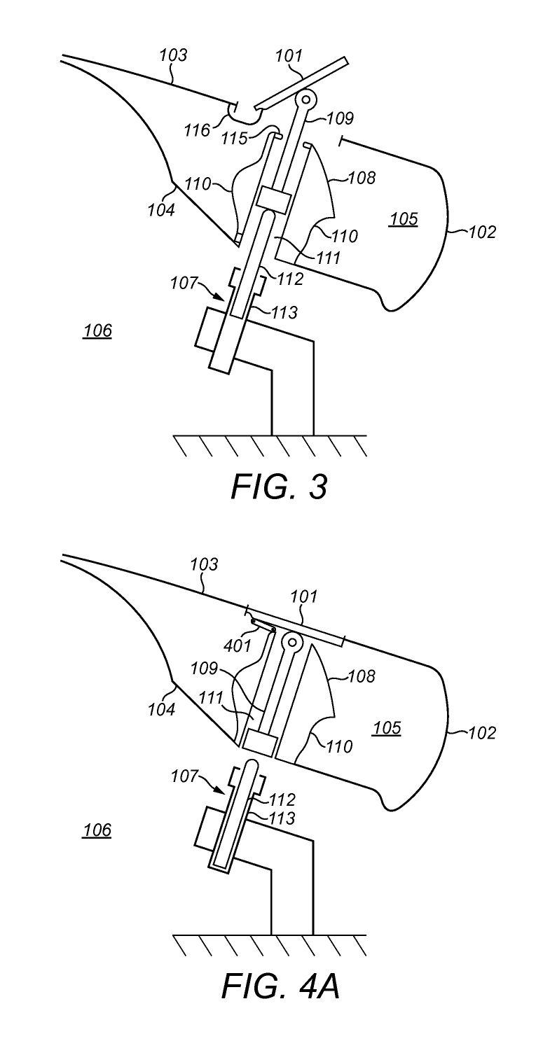

In FIG. 1 the aerodynamic device is shown in a retracted position. FIG. 3 shows a side view of the same section of the vehicle body as in FIG. 1 but with the aerodynamic device in a deployed position. When in the retracted position, the aerodynamic device lies substantially flush with the neighbouring upper skin of the door and the plunger is substantially housed within the channel 111. The piston of the actuator is in a retracted position so that it is substantially housed within the cylinder jacket 113. The plunger is held in place within the channel by springs 114 attached between the inner surface of the mounting structure defined by the channel and the shaft of the plunger. Suitably, when the aerodynamic device is in the retracted position the actuator is positioned so that the door can be opened leaving the actuator mounted to the vehicle body.

FIG. 2 shows the door in an open position. In this exemplary configuration, the door opens via a hinging motion such that rear-end of the door is raised higher than the front end relative to the ground on which the vehicle rests. The door may open by any other suitable mechanism depending upon the design of the vehicle to which the aerodynamic device is attached. Suitably, the retracted position of the actuator is chosen so that the door can be opened independently of the actuator. For example, the retracted position of the piston of the actuator may be such that it is not in contact with the base portion of the plunger (as is shown in FIG. 1). Alternatively, the upper end of the piston in the retracted position may be contiguous with the base portion of the plunger but not extending substantially into the hollow channel so as to obstruct the opening motion of the door. Because the relay mechanism is mounted to the door via the mounting mechanism, when the door is opened, the relay mechanism moves conterminously with the door but the actuator remains mounted to the vehicle body. Removing the actuator from the cavity of the door means that the weight of the door is reduced compared to doors in which the actuator moves with the door.

FIG. 3 shows the aerodynamic device in a deployed position. To move the aerodynamic device from the retracted position to a deployed position, the actuator is deployed into an extended position by moving the piston relative to the cylindrical jacket so as to engage the plunger. The piston extends so that its upper end becomes contiguous with the base portion of the plunger. Once the piston is touching the base portion, further extension of the piston drives the plunger through the hollow channel 111. During this motion, the piston and plunger move together. Driving the plunger through the channel causes the aerodynamic device to be raised relative to the neighbouring upper skin of the door. The piston can enter the chamber via the congruent opening in the lower skin. The range of motion through which the plunger can be moved can be controlled by the length of the hollow channel or the range through which the piston of the actuator is extendable. In this exemplary implementation a plug 115 is placed in the upper end of the channel so as to restrict the motion of the plunger. Suitably, the plug comprises a hollow centre so as to permit the shaft of the plunger to pass through but restrict the base portion of the plunger.

The upper end of the shaft of the plunger is pivotally connected to the aerodynamic device to allow the wing element to rotate about a horizontal axis as it is deployed. During deployment, the motion of the wing element can be constrained by hinges connecting the element to the vehicle body. For example, FIG. 3 shows a swan neck link 116 connecting the front end of the wing element to an adjacent portion of the upper skin. The function of the swan neck link is to constrain the motion of the wing element during deployment so that there is no substantial vertical gap between the front edge of the wing element and the adjacent upper skin. Alternatively, the hinges could be configured so that both the front and rear edges of the wing element are raised relative to the adjacent upper skin during the deployment of the aerodynamic device. An additional function provided by the swan-neck link is to constrain the wing element so that the airflow over the vehicle due to the vehicle's motion does not cause rotation of the wing element about a horizontal axis.

The aerodynamic device described with reference to FIGS. 1 to 3 functions as an airbrake. That is, deployment of the wing element into a deployed position increases the drag generated by the vehicle which aids the slowing of the vehicle. The down force generated by the vehicle will also be increased when the wing is deployed as an airbrake compared to the retracted position. However, in order for the wing element to function as a rear-wing for increasing down force, it is preferable for the down force to be generated without producing excessive drag. Preferably, both the front and rear edges of the wing element are raised relative to the adjacent upper skin when the wing is in a deployed position if the wing element is to function as a rear wing. Yet more preferably, the relative heights of the front and rear edges of the wing element relative to the adjacent bodywork are adjustable as the wing is deployed.

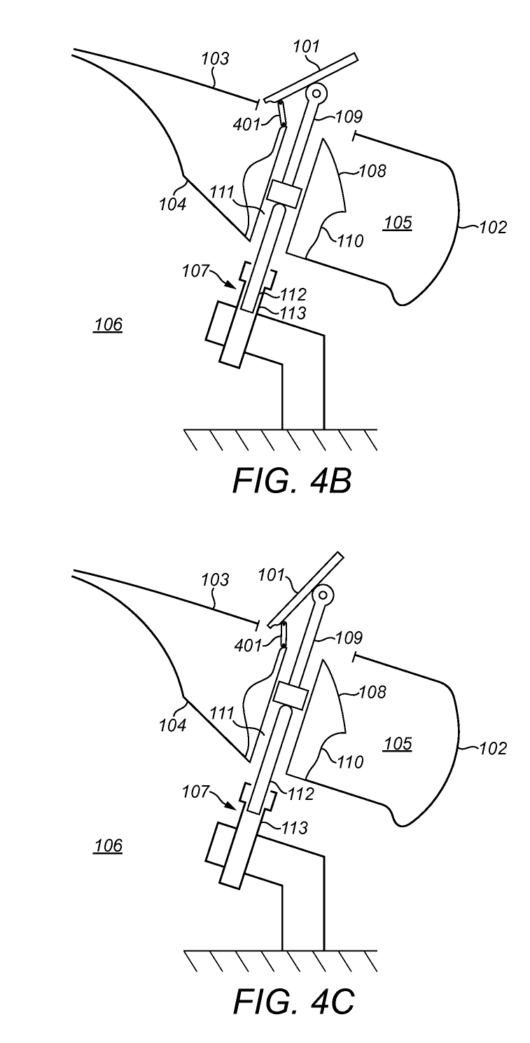

FIGS. 4a to 4c show a side view of a section of a vehicle comprising a system for controlling the deployment of a wing element for altering the down force generated by a vehicle. FIGS. 4a to 4c contain several of the same parts previously described with reference to FIGS. 1 to 3. The like parts will be labelled by like reference numerals. FIG. 4a shows the wing element in a retracted position. The relay mechanism comprises a strut 401 which is pivotally attached to the mounting structure 110 and to the wing element at a location offset from the attachment of the plunger. As the plunger is extended through the channel, the section of the wing element to which the plunger is attached is raised relative to the adjacent upper skin. Because the strut 401 is rigid, it rotates in a clock-wise direction which raises the front edge of the wing element relative to the adjacent upper skin. Thus this system is suitable for altering the down force generated by the vehicle since the actuator engages the relay mechanism to both raise the wing element relative to the adjacent bodywork and also to control the angle of attack of the wing element relative to the incoming airflow resulting from the vehicles motion. FIG. 4b shows an exemplary deployed position of the wing element functioning as a rear-wing.

The system described with reference to FIGS. 4a to 4c can be configured so that the wing element can function as both a rear wing and an airbrake. A suitable deployment of the plunger through the channel causes the strut to rotate such that the rear edge of the wing element is raised substantially higher than the front edge so that the wing element functions primarily as an airbrake. FIG. 4c shows an exemplary deployed position of the wing element functioning as an air-brake.

Configuring the actuator such that it remains mounted to the vehicle body as the door is opened provides a greater design freedom when considering packaging constraints. For instance, it eliminates the need to route cables for powering the actuator through the openable door. If the actuator was powered by hydraulics for example, these cables would be hydraulic lines. Alternatively if the actuator were an electric linear actuator, it would be served by electricity supply lines. Furthermore the packaging space required in the openable door is reduced because the actuator is housed on the vehicle body. This can lead to an openable door of reduced weight and a smaller cavity size.

In the systems described herein, the deployed position of the airbrake is controlled by the extension of the actuator. In practice, a vehicle may be equipped with a control system to control the deployment of the wing element in dependence on inputs that indicate the state of the vehicle, for example the speed of the vehicle or if the driver has pressed the brake pedal. In dependence on those inputs the control unit determines the optimum position of the wing element and controls the actuator accordingly. For example, if the actuator was hydraulically controlled, the control unit could control the supply of fluid to the actuator in dependence on the inputs. Alternatively, if the actuator were an electrically powered linear actuator, the control unit could output an electronic signal in dependence on the inputs.

A further advantage of the system described herein is that the actuator can function primarily to control the deployment of the wing element and does not need to bear a significant portion of the aerodynamic force generated by the element when in a deployed position. The aerodynamic forces generated by the wing element are lift and drag. The drag force acts in the direction of the incoming airflow when the vehicle is in motion. Typically, therefore, the drag force acts in a direction substantially parallel to the direction of the vehicles motion and in the opposite direction. The drag force produced by the wing element generates a torque that acts on any strut that extends between the wing element and the vehicle body. It is preferable for at least one strut extending from the wing element to resist this torque; failure to do so could result in the drag force altering the angle of attack of the wing, which would result in the wing element not generating its intended level of downforce or drag. In an extreme scenario, the torque generated by the drag force could cause a component failure.

In the systems described with reference to FIGS. 1 to 4, the mounting structure acts as a support to resist a substantial portion of the drag force. The drag force generated by the wing element is transmitted to the vehicle body by the mounting structure resisting the torque of the plunger. Because the base portion of the plunger is contiguous with the inner surface of the mounting structure defined by the hollow channel, the torque of the plunger is resisted by the support structure. Since a substantial portion of the drag force is transmitted to the vehicle body via the support structure, the actuator does not need to be designed to withstand a large torque. This in turn means the actuator can be of a reduced weight and simpler design.

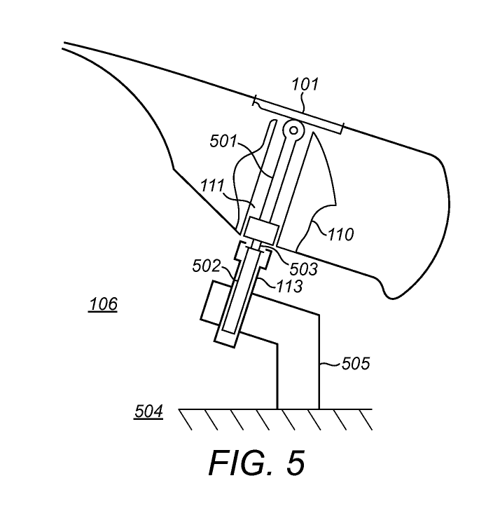

If the aerodynamic device is not to be attached to an openable door of the vehicle but simply to a fixed panel of the vehicle, the actuator can be permanently coupled to the plunger. Such a design could still employ a mounting structure for providing the means to transmit the drag force to the vehicle body. FIG. 5 shows a moveable aerodynamic device coupled to the body of a vehicle by means of an actuator and a plunger. A plunger 501 is pivotally attached at its upper end to a moveable aerodynamic device and attached at its lower end to an actuator 502 via a laterally mobile connection 503. The actuator has a lower end slideably located within a hollow cylinder jacket. The hollow cylinder jacket is mounted to the body of the vehicle 504 via a support structure 505. A mounting structure 110 is mounted to the vehicle body by means independent of the actuator. The mounting structure contains a hollow channel 111 through which the actuator can extend so as to move the aerodynamic device from a retracted position to a deployed position.

When the aerodynamic device is in a deployed position the drag force generated by the device is primarily transmitted to the vehicle body via the mounting structure. The mounting structure is configured so as to resist the torque of the plunger about a horizontal axis. Thus the actuator does not need to provide such a large resisting force to the torque.

The laterally mobile connection 503 permits relative movement between the plunger and the actuator and functions to reduce the resistant torque provided by the actuator. The laterally mobile connection could suitably be a spherical joint. Alternatively the laterally mobile connection could be a bushing. A suitable bushing could be a rubber bushing, which could provide for a small degree of relative movement between the actuator and the plunger.

In practice, the fit of the plunger within the channel may be designed with a degree of tolerance in order to provide for unwanted substances being deposited within the channel. For example, unwanted substances such as dirt and oil can build up within the channel over time, and a small tolerance can prevent these substances from restricting the movement of the plunger. On the other hand, actuators are often designed with relatively small tolerances, i.e., the fit of the actuator within the hollow cylinder jacket is substantially flush. The aerodynamic force generated by the wing element can cause the plunger to undergo a relatively small degree of lateral movement within the channel. The laterally mobile connection advantageously limits the transmission of this lateral movement to the actuator. If the actuator were fixedly coupled to the plunger, or if the plunger and actuator were a continuous portion, lateral movement within the channel would place a large torque on the actuator. With the design as shown in FIG. 5, lateral movement of the plunger within the channel causes relative movement between the plunger and actuator via the laterally mobile connection. This reduces the torque acting on the actuator and consequently, the actuator can be designed to withstand a smaller torque. This has the practical advantage of being able to use a lighter weight actuator.

The moveable aerodynamic device could be mounted on any suitable openable door of a vehicle, for example a rear boot lid, a front boot lid, a tailgate or a passenger entry door.

Instead of having actuators for moving each lateral end of the aerodynamic device, there could be a single actuator located along the centreline of the vehicle. Alternatively there could be more than two actuators.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A vehicle comprising:
a vehicle body;
an openable door having an outer skin and an inner skin defining a cavity there between and a relay mechanism mounted in the cavity;
a moveable aerodynamic device attached to the door for generating down force when in a deployed position relative to the vehicle; and
an actuator mounted to the vehicle body;
the vehicle being configured so that (i) the door can be opened, leaving the actuator mounted to the body, and (ii) when the door is closed, the actuator can engage the relay mechanism and drive the aerodynamic device via the relay mechanism to cause the aerodynamic device to extend to the deployed position.

2. The vehicle of claim 1 configured so that when the door is opened the relay mechanism moves with the door.

3. The vehicle of claim 1, wherein the openable door is a boot/trunk lid.

4. The vehicle of claim 1, wherein the actuator is a linear actuator.

5. The vehicle of claim 1, wherein the relay mechanism comprises a plunger constrained to move in a linear motion.

6. The vehicle of claim 5, wherein the plunger is attached to the aerodynamic device at a first location on the device.

7. The vehicle of claim 6, wherein the plunger is pivotally attached to the aerodynamic device.

8. The vehicle of claim 5 configured so that when the door is closed the actuator can engage the plunger and drive the aerodynamic device via the plunger to cause the aerodynamic device to extend to the deployed position.

9. The vehicle of claim 8, wherein the actuator is linearly extendable from a retracted position to a deployed position and the extension of the actuator engages the plunger and drives the plunger to move in a linear motion to cause the aerodynamic device to extend to the deployed position.

10. The vehicle of claim 9 configured such that, when the actuator has engaged the plunger, the extension of the actuator causes the actuator and the plunger to move together.

11. The vehicle of claim 1, wherein the aerodynamic device is extendable to the deployed position from a retracted position.

12. The vehicle of claim 11, wherein the aerodynamic device lies substantially flush with the outer skin of the openable door when in the retracted position.

13. The vehicle of claim 1, wherein the aerodynamic device comprises a wing element.

14. A vehicle comprising:
a vehicle body;
an aerodynamic device moveable between a retracted position and an extended position relative to an outer surface of the vehicle;
an actuator for moving the aerodynamic device relative to the outer surface of the vehicle; and
a support connected to the actuator via a laterally mobile connection, the support being constrained by means independent of the actuator for resisting a force generated by the aerodynamic device in the direction of the primary airflow over the aerodynamic device when the vehicle is in motion, and for engaging with the actuator to cause the aerodynamic device to move between the retracted position and the extended position.

15. The vehicle of claim 14, wherein the support comprises a mounting structure attached to the vehicle for resisting the force generated by the aerodynamic device.

16. The vehicle of claim 14, wherein the support comprises a plunger constrained to move in a linear motion and configured to engage with the actuator so as to move the aerodynamic device between the retracted position and the extended position.

17. The vehicle of claim 16, wherein the plunger is connected to the actuator via the laterally mobile connection.

18. The vehicle of claim 15, wherein the support comprises a plunger constrained to move in a linear motion and configured to engage with the actuator so as to move the aerodynamic device between the retracted position and the extended position; and wherein the plunger is constrained to move in a linear motion by the mounting structure.

19. The vehicle of claim 15, wherein the support comprises a plunger constrained to move in a linear motion and configured to engage with the actuator so as to move the aerodynamic device between the retracted position and the extended position; and wherein the plunger moves in a linear motion through a channel extending through the mounting structure.

20. The vehicle of claim 19 configured such that the actuator extends into the channel when engaged with the plunger to move the aerodynamic device between the retracted position and the extended position.

21. The vehicle of claim 14, wherein the support is attached to the aerodynamic device at a first location on the device.

22. The vehicle of claim 16, wherein the plunger is pivotally attached to the aerodynamic device at a first location on the device.

23. The vehicle of claim 15, wherein the actuator is mounted to the vehicle body independently of the mounting structure.

24. The vehicle of claim 14, wherein the aerodynamic device lies substantially flush with the outer surface of the vehicle when in the retracted position.

25. The vehicle of claim 14, wherein the laterally mobile connection is a spherical joint.

26. The vehicle of claim 14, wherein the laterally mobile connection comprises a bushing.
